(19) United States
(12) Patent Application Publication
(10) Pub. No.: US 2018/0320654 A1
(43) Pub. Date: Nov. 8, 2018

(54) A METHOD OF PREPARING A LIP-TYPE SHAFT SEAL FOR, A METHOD OF INSTALLING A LIP-TYPE SHAFT SEAL ON A SHAFT OF AN UNDERWATER APPLICATION AND A LIP-TYPE SHAFT SEAL THEREFOR

(71) Applicant: WÄRTSILÄ FINLAND OY, Vaasa (FI)

(72) Inventors: Henric ANNELUND, Vaasa (FI); Henrik LUNDGREN, Vaasa (FI)

(73) Assignee: WÄRTSILÄ FINLAND OY, Vaasa (FI)

(21) Appl. No.: 15/773,020

(22) PCT Filed: Nov. 9, 2015
(86) PCT No.: PCT/EP2015/076033

§ 371 Date: May 2, 2018

(51) Int. Cl. F03B 11/00; F16J 15/3272

(52) U.S. Cl. CPC F03B 11/006; F05B 2240/57; F16J 15/3272

(57) ABSTRACT

The present invention relates to a method of preparing a lip-type shaft seal for, a method of installing a lip-type shaft seal on a shaft of an underwater application, and a lip-type shaft seal therefor. Exemplary embodiments, can be especially advantageous as they can provide a lip-type shaft seal with a point of noncontinuity having such form-locking elements that the actual installation of the seal around the shaft under water may be performed by using the form-locking elements without the use of a habitat.

### TECHNICAL FIELD

The present invention relates to a method of preparing a lip-type shaft seal for, a method of installing a lip-type shaft seal on a shaft of an underwater application, and a lip-type shaft seal therefor. The methods and the lip-type shaft seal of the present invention are especially applicable in marine vessel or tidal turbine applications. The methods and the shaft seal of the present invention are particularly suitable when servicing shaft seals of a marine vessel or a tidal turbine.

### BACKGROUND ART

In accordance with prior art the outermost lip-type shaft seals preventing the seawater from leaking into the hull of a marine vessel have been serviced by divers such that a habitat has been arranged around the point to be serviced. The habitat means a tent-like structure that is fastened against the hull and/or the stern tube of the marine vessel in an air-tight manner such that the tent may be filled with air so that the person/people performing the servicing may work in an air atmosphere. The actual servicing of the seal, generally one or more lip-type shaft seals, is done such that the gland is loosened from the seal housing around the shaft or shaft liner, whereafter the gland and the seal/s may be drawn out of the housing. Each seal to be replaced is cut and removed from around the shaft/liner. When installing a new seal, it is first cut so that it may be positioned around the shaft/liner, whereafter the ends of the new seal are brought in a fixation jig. The ends of the seal are fastened to one another in the jig by applying epoxy on the cut surfaces and hardening the epoxy by using electrical heaters. It is the fastening phase of the ends of the seal that require the use of the habitat. The installation of the habitat and making it water-/air-tight is a cumbersome task that requires manpower and time.

Another prior art option is discussed in U.S. Pat. No. 4,500,096 disclosing a shaft seal, which is formed of two halves. The two halves and of the seal are aligned together around the shaft by vertical guide holes into which dowel pins are inserted. Once aligned, the two halves and are held together by bolts.

### BRIEF SUMMARY OF THE INVENTION

In view of the above, an object of the present invention is to develop a novel method of preparing a lip-type shaft seal for underwater installations such that the habitat is not needed.

Another object of the present invention is to develop such a novel method of installing a lip-type shaft seal on a shaft or a shaft liner of an underwater installation that the installation may be performed by a diver/divers without the need of habitat.

Yet another object of the present invention is to develop such a novel lip-type shaft seal that may be installed on a shaft or shaft liner of an underwater installation by a diver/divers without the need of habitat.

At least some of the above and other objects of the present invention are met with a method of preparing a lip-type shaft seal for an underwater application for underwater installation, the lip-type shaft seal having a lip section and a backing section, wherein the lip-type shaft seal is provided with a point of noncontinuity, the point of noncontinuity comprising two end surfaces, the end surfaces are provided with two or more form-locking elements, and at least one set of form-locking elements is provided at the lip section and at least one set of form-locking elements is provided at the backing section of the lip-type shaft seal.

At least some of the above and other objects of the present invention are also met with a method of installing a lip-type shaft seal for an underwater application, wherein the lip-type shaft seal is prepared for installation, above water, by providing the lip-type shaft seal with a point of noncontinuity comprising two end surfaces, by providing at least one set of form-locking elements at the lip section and at least one set at the backing section of the lip-type shaft seal and by providing the end surfaces with two or more form-locking elements, and the lip-type shaft seal is installed round a shaft or a shaft liner, underwater, by taking the lip-type shaft seal under water, by wrapping the lip-type shaft seal round the shaft or a shaft liner, and by form-locking the ends of the lip-type shaft seal to one another.

Other characteristic features of the present invention become evident from the appended dependent claims and the following description of the various embodiments of the present invention.

By applying the present invention at least some of the following advantages are gained:
simple servicing of the shaft seal, as the only thing needed to be performed under water is the installation of the seal in place around the shaft or shaft liner,
no need to perform any such operations underwater that would require the use of a habitat.

### BRIEF DESCRIPTION OF DRAWING

In the following, the method of preparing the lip-type shaft seal for, installing a lip-type shaft seal on a shaft of an underwater application, and a lip-type shaft seal therefor is discussed in more detail by referring to the appended drawings, of which

FIG. 1 illustrates schematically a prior art shaft seal,

FIG. 2 illustrates schematically a shaft seal in accordance with a first and a second preferred embodiments of the present invention,

FIG. 3a illustrates schematically in an enlarged scale an end view of a lip-type shaft seal in accordance with the first preferred embodiment of the present invention,

FIG. 3b illustrates schematically a second and a third lip seal sections of the lip-type shaft seal of the first preferred embodiment of the present invention in direction A-A of FIG. 3a,

FIG. 3c illustrates schematically a second and a third lip seal sections of the lip-type shaft seal of the first preferred embodiment of the present invention in direction B-B of FIG. 3b,

FIG. 4a illustrates schematically in an enlarged scale an end view of a lip-type shaft seal in accordance with the second preferred embodiment of the present invention,

FIG. 4b illustrates schematically a second and a third lip seal sections of the lip-type shaft seal of the second preferred embodiment of the present invention in direction C-C of FIG. 4a,

FIG. 4c illustrates schematically a second and a third lip seal sections of the lip-type shaft seal of the second preferred embodiment of the present invention in direction D-D of FIG. 4b,

FIG. 5a illustrates schematically a shaft seal in accordance with a third preferred embodiment of the present invention,

FIG. 5b illustrates schematically in an enlarged scale an end view of a lip-type shaft seal in accordance with the third preferred embodiment of the present invention,

FIG. 5c illustrates schematically ends of the lip-type shaft seal of the third preferred embodiment of the present invention in direction E-E of FIG. 5b, and

FIG. 5d illustrates schematically ends of the lip-type shaft seal of the third preferred embodiment of the present invention in direction F-F of Figure c.

### DETAILED DESCRIPTION OF DRAWINGS

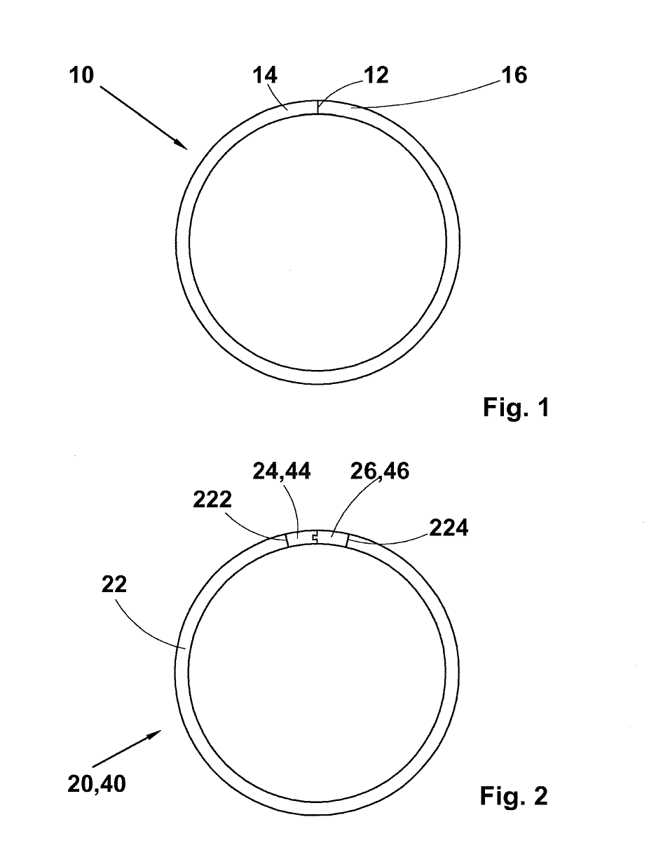

FIG. 1 illustrates schematically a prior art shaft seal 10. The shaft seal 10 has a radial cut 12 made when starting to install the seal ring round the shaft or shaft liner. The direction of the cut is of no importance as the cut ends will be joined together at a later stage. When the new seal is positioned round the shaft/liner, the ends 14 and 16 of the seal 10 are brought in a fixation jig. The end faces or cut surfaces of the seal 10 are fastened to one another in the jig by applying epoxy to the end or cut surfaces and hardening the epoxy by using electrical heaters. Since the fastening phase of the ends of the seal cannot be done underwater the use of the habitat around the shaft is required.

The only way the habitat may be avoided is to construct the lip-type shaft seal such that the lip-type shaft seal is provided beforehand with such ends that may be fastened to one another underwater by diver/s without a need to arrange an air atmosphere round the shaft/liner. Thus, in accordance with the present invention the ends of the lip-type shaft seal are provided with form-locking means such that the ends are connectable to one another underwater.

Since the underwater installation of the shaft seal requires that the seal has to be replaced without removing the propeller there is no other way than cut the seal such that it may be taken from around the shaft or shaft liner. In a similar manner it is required that the replacement seal may not be a continuous circular lip-type shaft seal, but it has to be provided with a cut for installation purposes. The traditional way of manufacturing the lip-type shaft seal for shaft sealing purposes is to mold the seal in a circular mold to its correct dimensions, whereby the seal is a continuous perfectly dimensioned annular ring. By manufacturing the seal like this, it is ensured that especially the lip, which is thin at its sealing edge, has exactly the desired shape and lip orientation. Now, that the present invention suggests the use of form-locking for joining the ends of the cut lip-type shaft seal to one another, it is, firstly, impossible to cut the lip-type shaft seal such that the surfaces formed when cut would contain the required form-locking elements, as the form-locking elements and other shapes required for ensuring the final sealing capability form a very complicated three-dimensional set of surfaces. Secondly, it is not possible to just make a radial cut to the lip-type shaft seal and then provide, i.e. by, for instance, grinding, the cut end surfaces, one at a time, with the required form-locking elements and other shapes required for ensuring the final sealing capability. The sole reason is that the circumferential length of the lip-type shaft seal would diminish significantly, whereby, if the ends of the lip-type shaft seal are, after grinding the form-locking elements and other shapes, brought together, the diameter would not be the same the lip-type shaft seal had after its production, but smaller. The lessening of the diameter inevitably results in such deformation (wrinkling etc.) of the thin seal lip that cannot be predicted, whereby the sealing capability and the durability of the lip-type shaft seal is at risk.

For the above reason, FIG. 2 illustrates schematically a lip-type shaft seal 20, 40 in accordance with the first and second preferred embodiments of the present invention formed of a three circumferentially extending lip seal sections 22; 24, 44 and 26, 46 all having, in a radial plane, an equal cross sectional profile. A first seal section 22 covers, preferably but not necessarily, most of the circumference of the shaft seal and has two end surfaces 222 and 224.

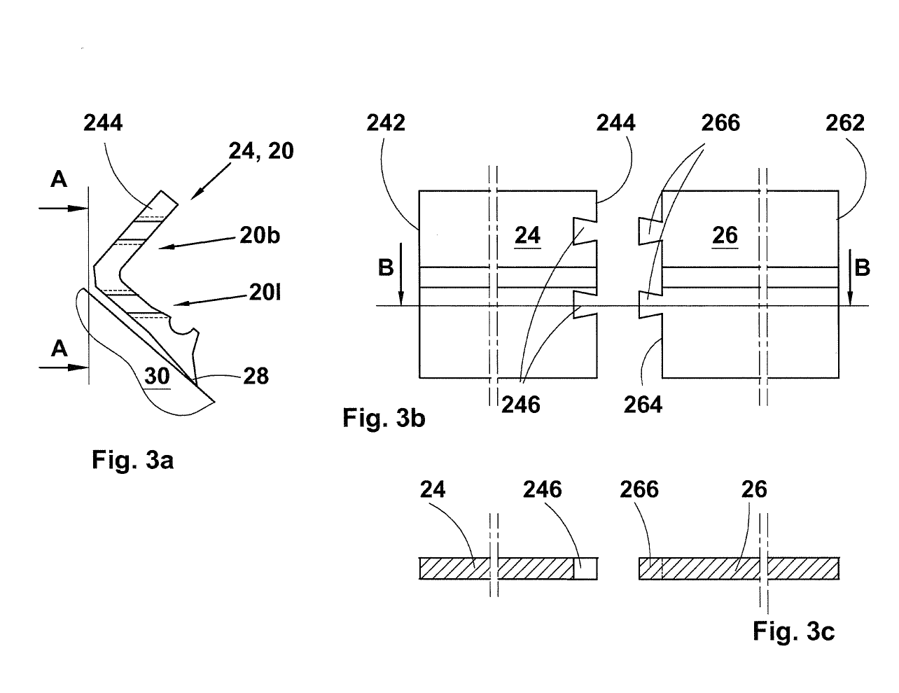

FIG. 3a illustrates schematically in an enlarged scale an end view of a lip-type shaft seal 20, in more detail the end of the second lip seal section 24, in accordance with a first preferred embodiment of the present invention. The cross section of the lip-type shaft seal 20 comprises a lip section 201 and a backing section 20b. The lip section 201 extends in the direction of the surface to be sealed, i.e. the surface of the shaft or the shaft liner, and comprises the lip 28 performing the actual sealing function, whereas the backing section 20b extends at substantially right angles to the lip section 201. The lip-type shaft seal 20 is arranged, when in operation, such that its lip 28 is pressed on the shaft or shaft liner shown schematically by reference numeral 30.

FIG. 3b illustrates schematically the second and third lip seal sections 24 and 26 of the shaft seal 20 of the present invention as seen from direction A-A of FIG. 3a, and FIG. 3c the second and the third lip seal sections 24 and 26 of the shaft seal of the first preferred embodiment of the present invention as seen from direction B-B of FIG. 3b. The second and third circumferentially extending lip seal sections 24 and 26, respectively, are, preferably, shorter than the first lip seal section 22 (FIG. 2), have, preferably but not necessarily, the same length, and have the same curvature as the first lip seal section. The second and third lip seal sections 24 and 26 have first and a second circumferential ends with first end surfaces 242 and 262 for fastening the second and third lip seal sections to the end surfaces 222 and 224 (FIG. 2) of the first lip seal section 22, and two second end surfaces 244 and 264 for fastening the second and third lip seal sections to one another, the end surfaces 244 and 264 also form the point of noncontinuity needed when installing the seal round the shaft or the shaft liner. In the preferred embodiment of the present invention discussed in FIG. 3b, the second end surface 244 of the second lip seal section 24 is provided with at least two grooves or notches 246 and the second end surface 264 of the third lip seal section 26 is provided with a projection 266 for each groove 246 of the second lip seal section 24. The groove has an internal shape matching the external shape of the projection. Each groove-projection pair forms a so called form-locking or dovetail fastening between the second lip seal section 24 and the third lip seal section 26. The at least two groove-projection pairs are located such that at least one pair is positioned at the lip section 201 (FIG. 3a) and at least one pair at the backing section 20b (FIG. 3a). Preferably, but not necessarily, there is one further groove-projection pair at the lip section 201. The second and third lip seal sections are preferably manufactured in the same fashion as the first lip seal section, i.e. by molding, with the exception that they are molded to a predetermined length, not to a full circle.

Naturally, it is also within the coverage of the present invention that both end surfaces 244 and 264 may have both groove/s and projection/s, as long as they are positioned such that they form a form-locking or dovetail fastening between the lip seal sections 24 and 26. It is also possible to replace the projection by a separate fastening member (for instance an hour-glass shaped member), whereby both end surfaces 244 and 246 of the second and third lip seal sections should have such grooves that match the shape of the separate fastening member. But in each case, there should be at least one set of form-locking elements at the lip section and one set at the backing section of the lip-type shaft seal. Preferably, but not necessarily, there is one further groove-projection pair at the lip section 201 and/or at the corner joining the lip section 201 and the backing section 20b.

As to all the grooves or notches 246 the direction thereof, i.e. the direction of the side surfaces or axis of the notches, is the same so that the projections 266 may be slid into the grooves from one single direction. The actual orientation of the side surfaces or axes of the notches and projections may be somewhere between parallel with the surface to be sealed and at right angles to the surface to be sealed.

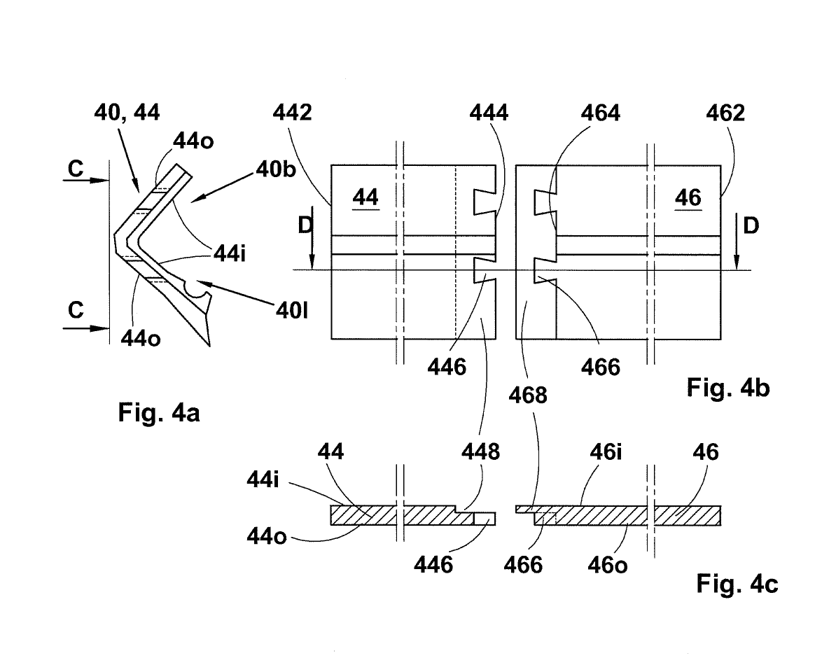

FIG. 4a illustrates schematically in an enlarged scale an end view of a lip-type shaft seal 40, in more detail the end of the second lip seal section 44, in accordance with a second preferred embodiment of the present invention. The cross section of the lip-type shaft seal 40 comprises a lip section 40l and a backing section 40b. The lip section 40l extends in the direction of the surface to be sealed, i.e. the surface of the shaft or the shaft liner, and comprises the lip performing the actual sealing function, whereas the backing section 40b extends at substantially right angles to the lip section 40l radially outwards from the surface to be sealed. The lip-type shaft seal 40 is arranged, when in operation, such that its lip is pressed on the shaft or shaft liner (not shown) in a similar manner as shown in FIG. 3a. FIG. 4a, as well as the other Figures of this embodiment discuss the inner surface 44i and the outer surface 44o of the first lip seal section 44. The inner surface 44i is considered to be the surface facing the interior of the seal housing when the sealing is installed in its place, and the outer surface 44o is considered to be the surface facing the shaft to be sealed, and continuing to the outer face of the support part of the seal.

FIG. 4b illustrates schematically the second and third lip seal sections 44 and 46 of the shaft seal 40 as seen from direction C-C of FIG. 4a, and FIG. 4c the second and the third lip seal sections 44 and 46 of the shaft seal of the second preferred embodiment of the present invention as seen from direction D-D of FIG. 4b. The second and third circumferentially extending lip seal sections 44 and 46, respectively, are, preferably, shorter than the first lip seal section 22 (FIG. 2) and have, preferably but not necessarily, the same length. The second and third lip seal sections 44 and 46 have first and second circumferential ends with first end surfaces 442 and 462 for fastening the second and third lip seal sections 44 and 46 to the end surfaces 222 and 224 (FIG. 2) of the first lip seal section 22, and two second end surfaces 444 and 464 for fastening the second and third lip seal sections 44 and 46 to one another, the end surfaces 444 and 464 also form the point of noncontinuity needed when installing the seal round the shaft or the shaft liner. In the second preferred embodiment of the present invention discussed in FIG. 4b, the second end surface 444 of the second lip seal section 44 is provided with at least two grooves or notches 446 and the second end surface 464 of the third lip seal section 46 is provided with a projection 466 for each groove 446 of the second lip seal section 44. The groove has an internal shape matching the external shape of the projection. Each groove-projection pair forms a so called form-locking or dovetail fastening between the second lip seal section 44 and the third lip seal section 46. The at least two groove-projection pairs are located such that at least one pair is positioned at the lip section 40l (FIG. 4a) and at least one pair at the backing section 40b (FIG. 4a). Preferably, but not necessarily, there is one further groove-projection pair at the lip section 40l, and/or at the corner joining the lip section 40I and the backing section 40b.

As to all the grooves or notches 446 the direction thereof, i.e. the direction of the side surfaces or axis of the notches, is the same so that the projections 466 may be slid into the groove from one single direction. The actual orientation of the side surfaces or axes of the notches and projections may be somewhere between parallel with the surface to be sealed and at right angles to the surface to be sealed.

However, as may be best seen in FIG. 4c the grooves 446 and the projections 466 of the second and third lip seal sections 44 and 46 do not extend for the entire thickness of the lip seal sections 44 and 46, but one of the lip seal sections, here in this embodiment the third lip seal section 46, is provided with an overhanging part 468 that continues as an extension of the inner surface 46i past the end surface 464 of the third lip seal section and the projection 466. In a corresponding manner the second lip seal section 44 is provided at its end or edge area with a pocket 448 recessed in the inner surface 44i of the second lip seal section for housing the overhanging part 468 when joining the second and third lip seal sections 44 and 46 together. In other words, the provision of the pocket 448 means that the edge area at the end of the second lip seal section 44 has a reduced thickness. The purpose of the overhanging part 468 and the pocket 448 is, in a way, to cover the form-locking elements 446 and 466 efficiently in order to improve the sealing capability of the joint at the ends of the sealing sections 44 and 46. As a further variation of the above discussed form-locking such a form-locking may be mentioned where the overhanging part has at its outer edge area either grooves or projections and the recessed pocket at its counter surface corresponding and cooperating projections or grooves.

Naturally, it is also within the coverage of the second preferred embodiment of the present invention that both end surfaces 444 and 464 may have both groove/s and projection/s, as long as they are positioned such that they form a form-locking or dovetail fastening between the lip seal sections 44 and 46. It is also possible to replace the projection by a separate fastening member (for instance an hour-glass shaped member), whereby both end surfaces 444 and 446 of the second and third lip seal sections should have such grooves that match the shape of the separate fastening member. As to the overhanging part 468 and the pocket 448, it should be understood that, due to the way the installation of the lip-type shaft seal is performed, they may be located at the end area of one of the first lip seal section and the second lip seal section only. However, the overhanging part may be located as an extension of whichever surface of the second and third lip seal sections, i.e. either being an extension of the inner surface of the lip seal section or that of the outer surface of the lip seal section. In a corresponding manner the pocket may be recessed in either the inner or outer surfaces of the second and third lip seal sections, as long as both the overhanging part and the pocket are on the same side of the lip seal sections, i.e. either on the inner or outer side thereof.

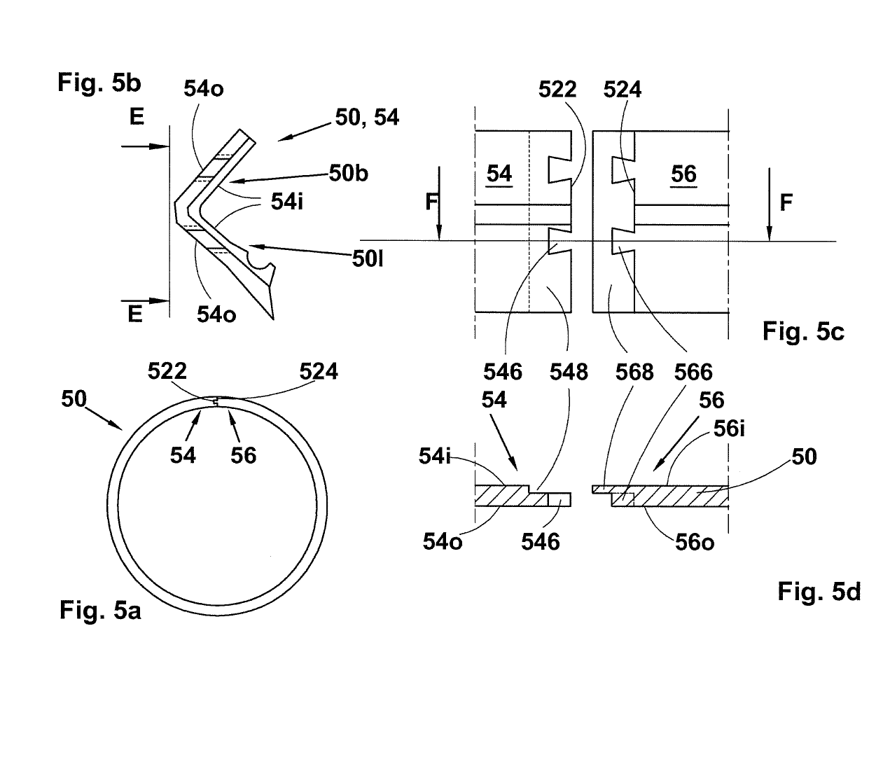

FIG. 5a illustrates schematically a lip-type shaft seal 50 in accordance with the third preferred embodiment of the present invention. The lip-type shaft seal 50 of the third preferred embodiment is an annular ring except for a point of noncontinuity, i.e. a point where the annular lip-type shaft seal 50 has a cut with a first end 54 and a second end 56 with end surfaces 522 and 524, respectively, the end surfaces 522 and 524 being provided with form-locking elements.

FIG. 5b illustrates schematically in an enlarged scale an end view of a lip-type shaft seal 50, in more detail the left hand side or first end 54 (of FIG. 5a) of the lip-type shaft seal 50. The cross section of the lip-type shaft seal 50 comprises a lip section 501 and a backing section 50b. The lip section 501 extends in the direction of the surface to be sealed, i.e. the surface of the shaft or the shaft liner, and comprises the lip performing the actual sealing function, whereas the backing section 50b extends at substantially right angles to the lip section 501 radially outwards from the surface to be sealed. The lip-type shaft seal 50 is arranged, when in operation, such that its lip is pressed on the shaft or shaft liner (not shown) in a similar manner as shown in FIG. 3a. FIG. 5b, as well as the other Figures of this embodiment discuss the first and 54 and the second end 56 of the lip-type shaft seal 50 with their end surfaces 522 and 524 having at least two pairs of grooves 546 and projections or notches 566 forming the form-locking means. What has been earlier discussed about the grooves and projections and the locations thereof, for instance in connection with FIGS. 3a-3c and 4a-4c, apply here, too. Thus, it is obvious that the third embodiment of the present invention has to variations, the first one comprising the ends 54 and 56 of the lip-type shaft seal having mere form-locking elements as discussed in FIGS. 3a-3c and the second one comprising the ends 54 and 56 of the lip-type shaft seal having form-locking elements and the overhanging part and the pocket therefor as discussed in FIGS. 4a-4c.

For the sake of clarity FIGS. 5b-5d discuss the second variation of the third preferred embodiment of the present invention. In FIG. 5b the inner surface 54i and the outer surface 54o of the lip-type shaft seal 50 are introduced. The inner surface 54i is considered to be the surface facing the interior of the seal housing when the sealing is installed in its place, and the outer surface 54o is considered to be the surface facing the shaft to be sealed, and continuing to the outer face of the support part of the seal.

FIG. 5c illustrates schematically the ends 54 and 56 of the shaft seal 50 as seen from direction E-E of FIG. 5b, and FIG. 5d illustrates the ends 54 and 56 of the shaft seal as seen from direction F-F of FIG. 5c. The ends 54 and 56 of the lip-type shaft seal 50 have end surfaces 522 and 524 for fastening the ends 54 and 56 of the shaft seal 50 to one another. In the second variation of the third preferred embodiment of the present invention discussed in FIG. 5c, the end surface 522 of the first end 54 of the lip-type shaft seal is provided with at least two grooves or notches 546 and the opposite end surface, i.e. the end surface 524 of the second end 56 of the lip-type shaft seal 50 is provided with a projection 566 for each groove 546 in the end surface 522. The groove has an internal shape matching the external shape of the projection. Each groove-projection pair forms a so called form-locking or dovetail fastening between the ends 54 and 56 of the lip-type shaft seal 50. The at least two groove-projection pairs are located such that at least one pair is positioned at the lip section 501 (FIG. 5b) and at least one pair at the backing section 50b (FIG. 5b). Preferably, but not necessarily, there is one further groove-projection pair at the lip section 501, and/or at the corner joining the lip section 501 and the backing section 50b.

However, as may be best seen in FIGS. 5c and 5d the grooves 546 and the projections 566 of the ends 54 and 56 of the lip-type shaft seal do not extend for the entire thickness of the lip-type shaft seal, but one of the ends 54 and 56, here in this variation of the third embodiment the second end 56 of the lip-type shaft seal 50, is provided with an overhanging part 568 that continues as an extension of the inner surface 56i past the end surface 524 of the second end 56 of the lip-type shaft seal and the projection 566. In a corresponding manner the first end 54 of the lip-type shaft seal 50 is provided at its edge area with a pocket 548 recessed in the inner surface 54i of the left hand side end of the shaft seal 50 for housing the overhanging part 568 when joining the ends of the lip-type shaft seal 50 together. In other words, the provision of the pocket 548 means that the edge area at the first end 54 of the lip-type shaft seal 50 has a reduced thickness. The purpose of the overhanging part 568 and the pocket 548 is, in a way, to cover the form-locking elements 546 and 566 efficiently in order to improve the sealing capability of the joint at the ends 54 and 56 of the lip-type shaft seal 50. As a further variation of the above discussed form-locking such a form-locking may be mentioned where the overhanging part has at its outer edge area either grooves or projections and the recessed pocket at its counter surface corresponding and cooperating projections or grooves.

Naturally, it is also within the coverage of the third preferred embodiment of the present invention that both end surfaces 522 and 524 may have both groove/s and projection/s, as long as they are positioned such that they form a form-locking or dovetail fastening between the ends 54 and 56 of the lip-type shaft seal 50. It is also possible to replace the projection by a separate fastening member (for instance an hour-glass shaped member), whereby both end surfaces 522 and 524 of the lip-type shaft seal should have such grooves that match the shape of the separate fastening member. As to the overhanging part 568 and the pocket 548, it should be understood that, due to the way the installation of the lip-type shaft seal is performed, they may be located at the end area of one of the first and the left end of the lip-type shaft seal only.

However, the overhanging part may be located as an extension of whichever surface of the first and second ends of the lip-type shaft seal, i.e. either being an extension of the inner surface of the lip-type shaft seal or that of the outer surface of the lip-type shaft seal. In a corresponding manner the pocket may be recessed in either the inner or outer surfaces of the lip-type shaft seal, as long as both the overhanging part and the pocket are on the same side of the lip-type shaft seal, i.e. either on the inner or outer side thereof.

The lip-type shaft seal may be manufactured, in accordance with a third preferred embodiment of the present invention, by molding such directly to a one piece lip-type shaft seal unit having a cut with form-locking elements. In other words, the lip-type shaft seal has two ends and end surfaces containing the form locking elements. In such a case the ends of the lip-type shaft seal may be as shown in FIGS. 3 and 4, especially in FIGS. 3b, 3c, 4b and 4c. It means that the mold is not a circular or an annular one in the manner traditional molds purposed for the production of circular/annular lip-type shaft seals are, but provided with an intermediate part closing the mold in circumferential direction such that the intermediate part includes the molds for the ends, the form-locking elements and, optionally, the overhanging parts and pockets of the lip-type shaft seal. Naturally, the diameter of the mold needs to be somewhat bigger than that of the lip-type shaft seal to be produced, to leave room for the end molds. Another option for the mold is that it is somewhat spiral, whereby the diameter of the mold may be the same as that of the lip-type shaft seal to be manufactured, so that the molds for the end surfaces, the form-locking elements and the optional overhanging parts and pockets are located somewhat staggered.

The actual replacement of the shaft seal, i.e. both the removal of the old seal and the installation of the new seal may, in accordance with the method of the present invention be performed by the diver/s without any need for the usage of the habitat. The servicing of the shaft seal or the installation of the new seal begins, applying the principles of the first and second embodiments discussed in FIGS. 2-4c, such that a new suitable lip-type shaft seal dimensioned particularly for the shaft or shaft sleeve in question is prepared beforehand somewhere above the water surface such that a certain length of the lip-type shaft seal (corresponding to the combined length of the second and third lip seal sections) is removed from a perfectly dimensioned full circular lip-type shaft seal to form a first lip seal section 22, 42. By removing the certain length of the lip-type shaft seal, while cutting the lip-type shaft seal, it is ensured that the radius of curvature of the lip remains, after the fastening of the second and third lip seal sections exactly the same as in the original lip-type shaft seal. The cuts are made, preferably, at right angles to the circumferential direction of the seal, though the cut may be, in practice in any direction, provided that the direction of the cut end surface 222, 422 and 224, 424 (FIG. 2) is the same as the direction of the end surfaces 242, 442 and 262, 462 of the second and third lip seal sections 24, 44 and 26, 46.

Thereafter properly dimensioned, of their circumferential length, second and third lip seal sections 24, 44 and 26, 46 are fastened to the end surfaces 222 and 224 (FIG. 2) of the first lip seal section 22, by inserting the ends 222 and 242 of the first lip seal section 22 and the second lip seal section 24 in the jig, applying epoxy between the surfaces 222 and 242, pressing the surface together and heating the epoxy, i.e. the jig, for curing the epoxy. The same is repeated with the opposite end of the first lip seal section 22 and the third lip seal section 26, i.e. by inserting the ends 224 and 262 of the first lip seal section 22 and the third lip seal section 26 in the jig, applying epoxy between the surfaces 224 and 262, pressing the surface together and heating the epoxy, i.e. the jig, for curing the epoxy. Only then the seal 20 is ready for installation. If the principles of the third embodiment are applied the new seal is either ordered from the seal manufacturer or taken from the inventory. In both cases, the prepared seal is given to the diver who takes it down below the bottom of the marine vessel, removes the old seal as described in prior art section of this application, wraps the new seal round the shaft and slides the dovetail fastening in place. When the new seal is pushed in its housing and locked in place by means of the gland, the form-locking fastening is not able to open. Thus, when using the method of the present invention, the full preparation of a new seal in condition for installation is performed beforehand above water level and the only action left, i.e. the installation of the seal round the shaft or shaft sleeve may be performed in or under water without any need whatsoever for the presence of dry atmosphere, i.e. habitat.

It is to be noted that above only a few most preferred embodiments of the present invention have been discussed. Thus, it is obvious that the invention is not restricted to the above described embodiments, but it may be applied in many different ways within the scope of the appended claims. The features of the present invention described in relation to a certain embodiment are within the basic concept of the invention, whereby they may be used in connection with another embodiment of the invention. Thereby also different features of the invention may be used in combination provided that such is desirable and the technical possibilities for that are available.

1. A method of preparing a lip-type shaft seal for an underwater application for underwater installation, the lip-type shaft seal having a lip section and a backing section, the method comprising:
a) providing the lip-type shaft seal with a point of noncontinuity, the point of noncontinuity comprising two end surfaces;
b) providing the end surfaces with two or more sets of form-locking elements; and
c) providing at least one set of form-locking elements at the lip section and at least one set of form-locking elements at the backing section of the lip-type shaft seal.

2. The method as recited in claim 1, comprising, in step b):
providing the end surfaces of the lip-type shaft seal with two or more grooves and/or projections.

3. The method as recited in claim 1, comprising, in step b):
providing both end surfaces of the lip-type shaft seal with both groove/s and projection/s.

4. The method as recited in claim 1, wherein the lip-type shaft seal has two ends, a first end with an inner surface and an outer surface, and a second end with an inner surface and an outer surface, the method comprising:
providing one of the inner surface and the outer surface of the first end with an overhanging part extending past the end surface and the form-locking elements of the first end; and
recessing a pocket at one of the inner surface and the outer surface of the second end.

5. The method as recited in claim 1, characterized by wherein the lip-type shaft seal has two ends, a first end with an inner surface and an outer surface, and a second end with an inner surface and an outer surface, the method comprising:
providing one of the inner surface and the outer surface of the second end with an overhanging part extending past the end surface and the form-locking elements of the second end; and
recessing a pocket at one of the inner surface and the outer surface of the first end.

6. The method as claim 1, comprising:
molding the lip-type shaft seal in one piece.

7. The method as recited in claim 1, comprising:
a) cutting a lip-type shaft seal for providing a first lip seal section with circumferential ends having a first end surface and a second end surface;
b) providing a second lip seal section with circumferential ends having a first end surface and a second end surface;
c) providing a third lip seal section with circumferential ends having a first end surface and a second end surface;
d) providing the end surface of the second lip seal section with one or more form-locking elements;
e) providing the end surface of the third lip seal section with one or more form-locking elements;
f) fastening the first end surface of the first lip seal section to a first end surface of the second lip seal section; and
g) fastening the second end surface of the first lip seal section to first end surface of the third lip seal section.

8. The method as recited in claim 7, by comprising, in step d):
providing the end surface of the second lip seal section with one or more grooves and/or projections.

9. The method as recited in claim 7, comprising, in step e):
providing the end surface of the third lip seal section with one or more grooves and/or projections.

10. The method as recited claim 7, wherein the second lip seal section has an inner surface and an outer surface the method comprising in step d):
providing one of the inner surface and the outer surface of the second lip seal section with either an overhanging part extending past the second end surface and the form-locking elements of the second lip seal section, or recessing a pocket at one of the inner surface and the outer surface of the second lip seal section.

11. The method as recited in claim 7, wherein the third lip seal section has an inner surface and an outer surface the method comprising in step e):
providing one of the inner surface and the outer surface of the third lip seal section with either an overhanging part extending past the second end surface and the form-locking elements of the third lip seal section, or recessing a pocket at one of the inner surface and the outer surface of the third lip seal section.

12. The method as recited in claim 7, comprising, in steps f) and g):
applying epoxy to at least one of the first end surface of the first lip seal section and the first end surface of the second lip seal section, and to at least one of the second end surface of the first lip seal section and the first end surface of the third lip seal section, pressing the surfaces together and heating the epoxy for curing thereof.

13. A method of installing a lip-type shaft seal for an underwater application, the lip-type shaft seal having a lip section and a backing section, comprising:
a) preparing the lip-type shaft seal for installation, above water, by
i. providing the lip-type shaft seal with a point of noncontinuity comprising two end surfaces,
ii. providing the end surfaces with two or more sets of form-locking elements, and
iii. providing at least one set of form-locking elements at the lip section and at least one set at the backing section of the lip-type shaft seal;
b) installing the lip-type shaft seal round a shaft or a shaft liner, underwater, by
i. taking the lip-type shaft seal under water,
ii. wrapping the lip-type shaft seal round the shaft or a shaft liner, and
iii. form-locking the ends of the lip-type shaft seal to one another.

14. The method as recited in claim 13, comprising, in step a) ii.:
providing the end surfaces of the lip-type shaft seal with two or more grooves and/or projections.

15. The method as recited in claim 13, characterized in comprising, in step a)ii.:
providing both end surfaces of the lip-type shaft seal with both groove/s and projection/s.

16. The method as recited in claim 13, wherein the lip-type shaft seal has two ends, a first end with an inner surface and an outer surface and a second end with an inner surface and an outer surface, the method comprising:
providing one of the inner surface and the outer surface of the first end with an overhanging part extending past the first end surface and the form-locking elements of the first end, and recessing a pocket at one of the inner surface and the outer surface of the second end.

17. The method as recited in claim 13, wherein the lip-type shaft seal has two ends, a first end with an inner surface and an outer surface and a second end with an inner surface and an outer surface, the method comprising:
providing one of the inner surface and the outer surface of the second end with an overhanging part extending past the second end surface and the form-locking elements of the second end, and recessing a pocket at one of the inner surface and the outer surface of the first end.

18. The method as recited in claim 13, comprising:
molding the lip-type shaft seal in one piece.

19. The method as recited in claim 13, comprising, in step a) i.:
1. providing a first lip seal section with circumferential ends having a first end surface and a second end surface,
2. providing a second lip seal section with circumferential ends having a first end surface and a second end surface,
3. providing a third lip seal section with circumferential ends having a first end surface and a second end surface,
in step a) ii.
4. providing the end surface of the second lip seal section with one or more form-locking elements,
5. providing the end surface of the third lip seal section with one or more form-locking elements,
and as step a):
iii. fastening the first end surface of the first lip seal section to a first end surface of the second lip seal section, and
iv. fastening the second end surface of the first lip seal section to first end surface of the third lip seal section,
and in step b) iii:
form-locking the second end surface of the second lip seal section and the second end surface of the third lip seal section together by utilizing the form-locking elements.

20. The method as recited in claim 19, comprising, in step a) ii. 4.:
providing the end surface of the second lip seal section with one or more grooves and/or projections.

21. The method as recited in claim 19, comprising, in step a) ii. 5.:
providing the end surface of the third lip seal section with one or more grooves and/or projections.

22. The method as recited in claim 19, comprising, in step b) iii.:
using a separate locking member for form-locking the second end surface of the second lip seal section and the second end surface of the third lip seal section together.

23. The method as recited in claim 19, wherein the second lip seal section has an inner surface and an outer surface, and the third lip seal section has an inner surface and an outer surface, the method comprising:
providing one of the inner surface and the outer surface of the second or third lip seal section with an overhanging part extending past the second end surface and the form-locking elements of the second or third lip seal section; and
recessing a pocket at one of the inner surface and the outer surface of the second or third lip seal section.

24. A lip-type shaft seal for sealing a shaft or a shaft liner of an underwater application, the lip-type shaft seal having a lip section and a backing section, wherein the lip-type shaft seal comprises:
a point of noncontinuity, the point of noncontinuity being formed of two end surfaces, the two end surfaces being provided with two or more sets of form-locking elements such that at least one set of form-locking elements is provided at the lip section and at least one set of form-locking elements is provided at the backing section.

25. The lip-type shaft seal as recited in claim 24, characterized in that wherein the end surfaces of the lip-type shaft seal are provided with two or more grooves and/or projections.

26. The lip-type shaft seal as recited in claim 24, wherein both end surfaces of the lip-type shaft seal are provided with both groove/s and projection/s.

27. The lip-type shaft seal as recited in claim 24, wherein the lip-type shaft seal has two ends, a first end with an inner surface and an outer surface and a second end with an inner surface and an outer surface, that one of the inner surface and the outer surface of the first end being provided with an overhanging part extending past the first end surface and the form-locking elements of the first end; and
a pocket recessed at one of the inner surface and the outer surface of the second end.

28. The lip-type shaft seal as recited in claim 24, wherein the lip-type shaft seal has two ends, a first end with an inner surface and an outer surface and a second end with an inner surface and an outer surface, one of the inner surface and the outer surface of the second end being provided with an overhanging part extending past the second end surface and the form-locking elements of the second end; and
a pocket is recessed at one of the inner surface and the outer surface of the first end.

29. The lip-type shaft seal as recited in claim 26, wherein it is formed of three circumferentially extending lip seal sections; a first lip seal section, a second lip seal section and a third lip seal section.

30. The lip-type shaft seal as recited in claim 29, wherein the first lip seal section has two circumferential ends with two end surfaces, the second lip seal section having two circumferential ends with two end surfaces, and the third lip seal section having two circumferential ends with two end surfaces.

31. The lip-type shaft seal as recited in claim 30, wherein the first end surface of the first lip seal section is fastened to the first end surface of the second lip seal section, the second end surface of the first lip seal section is fastened to the first end surface of the third lip seal section, and the second end surfaces of the second and third lip seal sections is provided with form-locking elements.

32. The lip-type shaft seal as recited in claim 31, comprising:
an overhanging part extending past the second end surface and the form-locking elements of the second or third lip seal section; and
a pocket at the second end of the second or third lip seal section.

33. The lip-type shaft seal as recited in claim 32, wherein the overhanging part is an extension of the inner surface of the second or third lip seal section, and the pocket is recessed in inner surface of the second or third lip seal section.

34. The lip-type shaft seal as recited in claim 32, wherein the overhanging part is an extension of the outer surface of the second or third lip seal section, and the pocket is recessed in outer surface of the second or third lip seal section.
